(19) United States
(12) Patent Application Publication
(10) Pub. No.: US 2007/0039677 A1
(43) Pub. Date: Feb. 22, 2007

(54) Method and system for controlling label peeling and rejecting bad labels in a label printer or applicator system

(76) Inventor: Theodore A. Chapman, San Juan Capistrano, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/497,456

(22) Filed: Aug. 1, 2006

Related U.S. Application Data
(60) Provisional application No. 60/709,496, filed on Aug. 19, 2005.

(51) Int. Cl. B29C 63/00; B32B 41/00

(52) U.S. Cl. 156/64; 156/361; 156/378; 156/344; 156/584

(57) ABSTRACT

Instead of raising and lowering the tension in a full length of a liner with labels affixed thereto, the tension in a small portion of the liner is temporarily reduced, such as by clamping the liner between a tensioning device (usually a rewinder) and a peel point. The overall liner tensioning system is not affected. After the leading edge of a bad label is driven past the peel point, the tension is resumed, such as by releasing the clamping. The bad label then remains on the liner. This type of a mechanism allows rapid and precise control of tension at the peel point without having to control the overall tensioning system for the liner.

### CROSS REFERENCE TO RELATED APPLICATIONS

The present invention claims priority to U.S. Provisional Application Ser. No. 60/709,496, filed Aug. 19, 2005, and which is incorporated by reference in its entirety.

### BACKGROUND

1. Field of Invention

The present invention relates to label printers and applicators and, in particular, to mechanisms to handle labels in the printers and applicators.

2. Related Art

Typically, labels contain identifying information for packages and products. The labels are affixed to the packages so that the package or contents thereof can be identified or tracked without opening the package. Traditional labels have visually or optically readable information printed on them, such as alphanumeric text or barcodes. More recently, labels have used RFID (Radio Frequency Identification) tags embedded therein to store and convey information.

Regardless of the type of label, printers and applicators are used to apply the labels to packages. The labels are generally adhered to a web or liner, where the web is wound around a reel. As labels are unwound from the reel, they are written to, e.g., by a thermal print head, impact printing, or other suitable ink transferring method, or by an RFID encoder, with the desired information. The labels are then separated from the liner by a peel operation, thereby enabling the printed or dispensed label to be presented to an operator or applicator in a state ready to be directly applied to a product or package.

This peel operation generally consists of some sort of sharp-edged peel plate around which the label liner is wrapped under tension. As the label stock moves across this peel plate to the peel point, the liner is wrapped at a tight angle with respect to the direction of motion of the label, causing the leading edge of each label to separate from the liner at the peel point. The label itself (due to the stiffness of its material) continues to move in the same direction of travel, while the liner is wrapped and moves in a new direction, often 90 degrees or more from the direction of the label. This operation allows the label to be presented to an operator or applicator with the liner removed and the adhesive surface of the label uncovered and ready to apply to a package or product.

Conventionally, each label is peeled from the liner regardless of the label quality. So, if a label is defective or bad, such as mis-printed information, unreadable tag or label, or improperly encoded tag, the bad label still is affixed to the package. This renders the package identification worthless or worse yet, in error. So, it is desirable to only peel off good labels and leave bad labels on the liner to be wound onto a discard take-up spool with the waste liner rather than given to an operator or applicator for application to a package or product.

Liners are generally wound onto a take up spool after the labels have been removed from them. This rewind system creates the tension in the liner—it is typically a servo driven motor that must compensate for liner roll diameter to keep constant tension. Other methods of controlling tension at the peel point have involved some sort of mechanism that actually relaxes the tension created by the tensioning system over the entire length of the liner. This is effective, but is a slow and imprecise operation. It does not allow tightly controlling peel or no-peel of small labels spaced closely together on a liner.

Therefore, there is a need for a mechanism for a controlling the peel operation for a printer or applicator that overcomes the disadvantages of conventional mechanisms discussed above.

### SUMMARY

According to one aspect of the present invention, a tensioning mechanism is located close to a peel plate of a label applicator, where the tensioning mechanism relieves tension on a label liner near the peel plate when a bad label is detected. As a result, the bad label is not peeled and remains affixed to the liner, where it is wound up with the liner in a take-up reel or spool. The tensioning mechanism only relieves the tension along a small portion of the liner, which provides numerous advantages in a system for selectively peeling or not peeling labels.

In one embodiment, the tensioning mechanism is a clamp. The roll of labels is fed across a print head, such as an RFID encoder/reader, by a platen or other suitable mechanism. The peel plate is located past the platen. The labels are peeled off the liner as they move over the end of the peel plate, with tension being supplied by a take-up reel located at an angle of 90 degrees or greater from the path of the labels along the peel plate. When a bad label is detected, such as by the RFID encoder/reader or other label reader, the clamp closes to clamp the liner, resulting in tension being released between the clamp and the peel plate as the platen drives the label forward. This then prevents the bad label from being peeled from the liner. Once the front of the bad label has sufficiently passed the peel plate, the clamp is opened again, allowing the bad label to remain on the liner and travel to the take-up reel.

In another embodiment, the tensioning mechanism is a driver roller assembly. The assembly can be two opposing drive rollers or one drive roller and opposing freely rotating roller. The driver roller assembly provides tension to the liner by pulling the liner past the peel plate and toward the take-up roller. Upon a bad label detection, the rollers are opened up so that the bad label is moved past the peel plate with little or no tension, enabling the bad label to stay on the liner. After the bad label has past the peel plate, the rollers are closed again, thereby resuming tension to the liner for normal label peeling operation.

The present invention provides several advantages over conventional mechanisms, such as the ability to precisely control the peel or no-peel operation for very small labels, ease of design/manufacture using a simple clamping mechanism, conventional peel plates, and existing mechanisms to loosen the tension, e.g., the platen drive system, simpler operation since no need to decrease or increase the tension on the entire used liner, and very fast operation for engagement and disengagement of the peel/no peel process. The clamping device can be implemented in the form of drive rollers which start and stop and can also be used to create the peel tension on the liner. The drive rollers can also be used to increase tension by driving the liner toward the take-up reel or decrease tension by reversing its drive. The tensioning mechanism that creates the correct peel tension does not have to drop and regain tension for each bad label—an action that can create inconsistency in label peel tension.

Embodiments of the present invention and their advantages are best understood by referring to the detailed description that follows.

### BRIEF DESCRIPTION OF THE DRAWING

FIG. 1 shows a portion of a system for controlling a peel operation on labels affixed to a liner according to one embodiment of the present invention; and

FIG. 2 shows a flow chart for steps in controlling a peel operation according to one embodiment.

It should be appreciated that like reference numerals are used to identify like elements illustrated in one or more of the figures.

### DETAILED DESCRIPTION

According to one aspect of the present invention, a tensioning mechanism in a label printer/applicator system is placed close to the peel plate so that tension or release of tension can be quickly and accurately applied, resulting in better control of whether a bad label is peeled or retained on a liner.

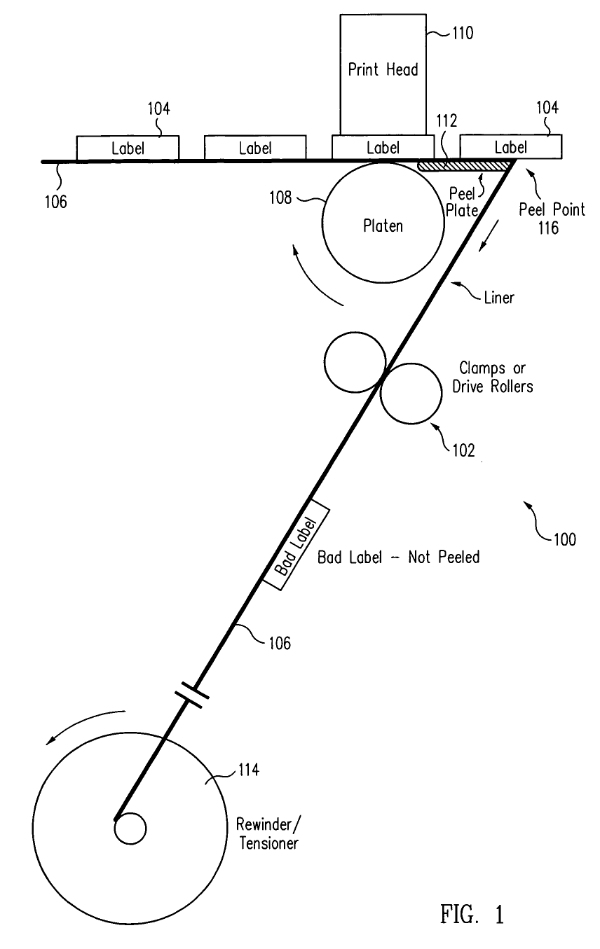

FIG. 1 shows a portion of a label printer or applicator system 100 using a tensioning mechanism 102 according to one embodiment of the present invention. System 100 includes labels 104 adhered to a web or liner 106. Labels 104 can be any suitable label, such as a bar code label or other label containing visually/optically readable data or an RFID label with an embedded RFID tag to store desired data. A platen 108 or other suitable roller moves labels 104 across a print head 110 for reading and/or writing to each label. In some embodiments, the labels are printed or encoded prior to reaching print head 110 so that print head 110 only reads the information printed on or stored in the labels. In other embodiments, print head 110, in addition to reading, also writes to or encodes the labels. For optically readable labels, print head 110 may be a thermal print head or any other suitable ink delivering device. For RFID labels, print head 110 may be an RFID encoder/verifier.

System 100 also includes a peel plate 112 or other conventional peel mechanism located past print head 110. A take-up reel or spool 114 is located an angle of approximately 90° or greater from the path of labels 104. As a result, when individual labels travel past the end of peel plate 112, i.e., a peel point 116, tension on liner 106 causes the label to separate from the liner. The label can then be applied to a desired package or product or otherwise used in a downstream application.

However, when a bad label is detected, such as by print head 110, the bad label should not be peeled off and should remain on liner 106 to be wound onto take-up spool 114. A bad label indication may occur in many different ways. For example, with a bar code label, a bad label is detected when the desired information is mis-printed or the printed information is unreadable. With an RFID label, a bad label is detected when desired information is not encoded properly into the RFID tag or when the tag is unreadable by the RFID reader. Depending on the tolerances for the labels, a bad label may even be indicated when the printed information (e.g., bar code) does not meet certain standards, even though the information is correct and can be read. Thus, in general, the system determines, based on its desired performance and criteria, whether a label is “bad” and thus should not be used, such as attachment to a package or product.

Tensioning mechanism 102 is located near peel plate 112, between peel plate 112 and take-up spool 114. The tensioning mechanism 102 would typically be located within a few inches of the peel point and may be up to several feet away from the take-up spool 114. The distance from tensioning mechanism 102 to peel point 116 can depend on various factors, such as the length of the label, the face stock thickness, the type of adhesive used, and the liner rigidity. In one embodiment, the distance from the tensioning mechanism to the peel point is approximately the same as the length of the label. For example, for a 6″ label, the distance is approximately 6″, and for a 2″ label, the distance is approximately 2″ to 3″. The distance from tensioning mechanism 102 to take-up spool 114 also depends on various factors, with a major factor being the distance from take-up spool 114 to peel point 116. For example, at small distances, such as 12″, the tensioning mechanism can be at least 6″ from the take-up spool. For longer distances, the distance from the tensioning mechanism to the take-up spool is determined by the minimum distance to the peel point, as discussed above.

When a bad label is detected, tensioning mechanism 102 reduces or relieves tension along the portion of the liner between tensioning mechanism 102 and peel plate 112. As a result, the bad label does not peel off the liner, but instead remains on the liner where it is rolled up into take-up spool 114.

In one embodiment, tensioning mechanism 102 comprises a pair of opposing clamps, which clamp down onto liner 106 when a bad label is detected. In normal operation, the clamps are in an open position such that liner 106 is free to move between the clamps. In this embodiment, take-up spool 114 also functions to provide sufficient tension on liner 106 to enable labels to be peeled off the liner as the labels travel past peel point 116, i.e., take-up spool pulls liner away from the peel plate.

When a bad label is detected, the clamps clamp down on liner 106, which results in a near instantaneous decrease in tension between platen 108 and tensioning mechanism 102 as the label is driven forward by platen 108. This causes extra liner to be moved or driven past peel point 116 instead of being pulled down along the edge of the peel plate. As a result, the bad label remains affixed to liner 106. Once the leading edge of the label is driven past peel point 116, the clamps of tensioning mechanism 102 are opened, which allows take-up spool 114 to quickly take up the extra liner and create the desired tension in the liner for the normal peel operation. The bad label remaining on liner 106 is then wound onto take-up spool 114.

In another embodiment, tensioning mechanism 102 comprises a driver roller assembly, in which two opposing rollers engage to pull liner 106 along peel plate 112 and create sufficient tension in the liner to peel off labels as the labels move past peel point 116. In one embodiment, one of the rollers is freely rotating, while the other roller actually drives the liner, such as by a motorized mechanism. When the two rollers are brought together against the liner, the driver roller moves the liner and the freely rotating roller provides resistance against the liner and drive roller, while not impeding the motion of the liner. In another embodiment, the two opposing rollers are both drive rollers, e.g., both actively drive, such as by motorized mechanical assemblies.

With tensioning mechanism 102 comprising a drive roller assembly, the rollers release or open up when a bad label is detected. Upon release, the tension in the liner between tensioning mechanism 102 and peel plate 112 is immediately lessened, resulting in excess liner moving past peel point 116 instead of being pulled directly against it. This keeps the bad label affixed to the liner. As the leading edge of the bad label passes peel point 116, the rollers are closed against the liner, thereby quickly pulling in the excess liner and resuming the normal tension on the liner.

Thus, the system of the present invention enables rapid and precise control of tension at the peel plate, which enables bad labels in a liner of small and/or closely spaced labels to be retained on the liner and good labels to be removed from the liner.

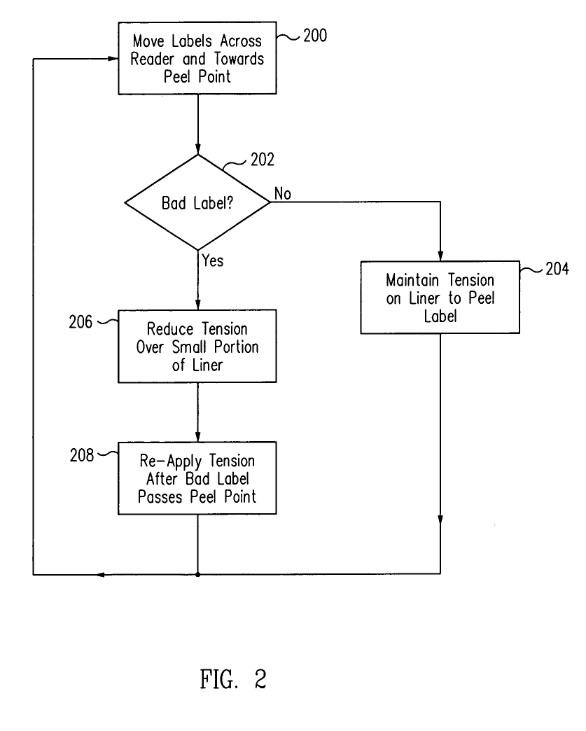

FIG. 2 is a flow chart illustrating a method of controlling a label peel operation according to one embodiment of the present invention. At operation 200, a roll of labels on a liner is moved across a label reader and toward a peel point, which is at the end of a peel plate in one example. The label reader can be a print head, RFID encoder, or any suitable mechanism for reading and/or writing to a label. A platen or other mechanism can be used to move the labels. At operation 202, a determination is made as to whether an individual label is bad, where “bad” can be based on any number of different criteria, such as whether data was written correctly, whether the label can be properly read, or whether the information on the label meets certain quality requirements. The determination can be made by reading or attempting to read information on the label, such as with a barcode or RFID reader.

If the label is good, i.e., not bad, then the label is peeled off the liner, at operation 204, by maintaining tension to the liner as the label and liner pass by the peel point. The next label is then moved toward the peel point. Note that this movement is continuous, but may be halted temporarily if desired. If as determined at operation 202 that the label is bad, tension to only a small portion of the liner, e.g., from the peel point to a short length right after the peel point, is reduced at operation 206. The reduction in tension can be by clamping down on the liner right after the peel point to temporarily prevent tension from being applied between the clamping point and the peel point or by releasing driver rollers to temporarily disengage the tensioning mechanism. This temporary disengagement is sufficient to allow the bad label to remain on the liner, where it is moved toward a take-up reel and wound up with the liner.

After the leading edge of the bad label has passed the peel point, tension is re-applied at operation 208, such as by releasing the clamps or re-engaging the drive rollers. The next label is then moved toward the peel point. In this fashion, once a bad label is detected, the system can quickly reduce tension in a small portion of the liner so that the label does not peel off. Tension can then be quickly re-applied to the liner so that the next label can be peeled off the liner if desired.

In one embodiment, upon detection of a bad label at operation 202, the system writes or encodes the same information on the following label. This can be accomplished by sending a signal to the print head or other writing mechanism, such that as the bad label is rejected, a good label is subsequently and quickly presented to the operator or applicator. In another embodiment, the bad label may also be over-written and/or over-encoded by the print head to give visual and/or encoded indication that the label is unusable.

In yet another embodiment, after tension is reduced at operation 206, such as by the tensioning mechanism clamping the liner, the entire tensioning mechanism may be moved in the direction of the take-up spool at approximately the same speed as the liner is driven by the platen. As a result, the amount of slack in the liner can be minimized and the liner tension can be quickly and accurately regained upon release of the clamping mechanism.

Such a system can be implemented using conventional circuitry. For example, once a bad tag or label is detected, which can be at any point prior to the label reaching the peel point, a signal is sent to a processor or circuitry controlling the operation of the clamps, drive rollers, and/or the take-up spool (e.g., rewinder/tensioner). Once the “bad label signal” is received, a signal can be transmitted to the suitable element(s) for enabling a desired action. For example, a clamp or clamps can be closed or rollers can be ceased or separated. The action can then be stopped, as determined by the associated processor, software, or circuitry. When the action is stopped can depend on various factors. These include, but are not limited to, the location of the label when the bad label is detected and the signal sent, the speed of the label, the length of the label, the amount of adhesion between the label and liner, the angle at the peel point, the stiffness of the label or liner, and/or the efficiency of the clamping or driving (which may determine how quickly the action has to be initiated so that there is sufficient tension reduction at the peel point to prevent the label from peeling). As a result, the system can be automated so that whenever a bad label is detected by the system (or by user input), the bad label is automatically kept on the used liner portion to be discarded.

Having thus described embodiments of the present invention, persons skilled in the art will recognize that changes may be made in form and detail without departing from the scope of the invention. For example, specific mechanisms were described for temporarily reducing the tension to a small portion of the liner. However, any other suitable device can also be used. Thus the invention is limited only by the following claims.

What is claimed is:

1. A system for controlling a label peeling operation on a roll of labels on a liner, comprising:
a label reader for determining whether a label on the liner is bad and generate a signal indicating a bad label;
a take-up spool onto which the liner is wound; and
a tension reducer located between the label reader and the take-up spool, wherein the tension reducer, in response to the bad label signal, temporarily reduces tension a portion of the liner between the tension reducer and a peel point for the labels.

2. The system of claim 1, wherein the tension reducer comprises a first clamp and an opposing second clamp, wherein the liner is between the first and second clamps.

3. The system of claim 2, wherein the take-up spool is configured to provide sufficient tension to the liner to enable labels to be peeled off the liner as the labels pass the peel point.

4. The system of claim 2, wherein the first and second clamps clamp the liner when the bad label signal is received.

5. The system of claim 1, wherein the tension reducer comprises a first drive roller configured to provide sufficient tension to the liner to enable labels to be peeled off the liner as the labels pass the peel point.

6. The system of claim 5, wherein the tension reducer further comprises a freely rotating roller, wherein the liner is between the first driver roller and the freely rotating roller.

7. The system of claim 5, wherein the tension reducer further comprises a second drive roller, wherein the liner is between the first and second drive rollers.

8. The system of claim 5, wherein the first drive roller stops driving the liner when the bad label signal is received.

9. The system of claim 1, wherein the labels are RFID labels.

10. The system of claim 1, wherein the tension reducer is separated from the peel point by a distance approximately the same as or less than a length of the label.

11. The system of claim 1, further comprising a platen located behind the peel point, wherein the platen moves the labels toward the peel point.

12. The system of claim 11, further comprising a peel plate between the platen and the tension reducer.

13. The system of claim 1, wherein the tension reducer is configured to move toward the take-up spool during the time the tension is reduced in the liner.

14. The system of claim 13, further comprising a platen located behind the peel point, wherein the platen moves the labels toward the peel point and wherein the tension reducer moves at approximately the same speed as the labels are moved by the platen.

15. A system for controlling label peeling in a printer or applicator system comprising:
means for moving labels affixed to a liner toward a peel point;
means for determining whether a label affixed to the liner is bad;
means for providing tension to the liner at the peel point sufficient to peel the label from the liner; and
means for reducing tension in a shortened portion of the liner between the peel point and a take-up spool when a bad label is detected.

16. The system of claim 15, wherein the means for reducing allows the tension providing means to quickly provide the sufficient tension to the liner when the bad label is moved past the peel point.

17. The system of claim 15, wherein the means for moving comprises a platen.

18. The system of claim 15, wherein the means for determining comprises a label reader.

19. The system of claim 16, wherein the label reader comprises an RFID reader.

20. The system of claim 15, wherein the means for reducing comprises a pair of clamps.

21. The system of claim 15, wherein the means for reducing comprises a drive roller assembly.

22. A method for controlling a label peeling operation on a roll of labels affixed to a liner, comprising:
moving the labels toward a peel point;
determining whether a label affixed to the liner is bad;
reducing tension in a shortened portion of the liner between the peel point and a take-up spool when a bad label is detected to prevent the bad label from peeling from the liner; and
providing tension to the liner at the peel point sufficient to peel the labels from the liner when a bad label is not detected.

23. The method of claim 22, wherein if a bad label is detected, writing the same information to an immediately subsequent label.

24. The method of claim 23, wherein the writing comprises encoding.

25. The method of claim 22, wherein if a bad label is detected, writing to the label to indicate the label is bad.

26. The method of claim 25, wherein the writing comprises encoding.

27. The method of claim 22, wherein the tension is reduced by temporarily clamping the liner with a clamping mechanism when a bad label is detected.

28. The method of claim 27, further comprising moving the clamping mechanism toward the take-up spool at approximately the same speed as the labels are moved.
